(19) United States
(12) Patent Application Publication
(10) Pub. No.: US 2013/0294519 A1
(43) Pub. Date: Nov. 7, 2013

(54) COMPLEXITY SCALABLE FRAME RATE-UP CONVERSION

(71) Applicants: Marat Gilmutdinov, Saint-Petersburg (RU); Anton Veselov, Saint-Petersburg (RU); Ivan Grokhotkov, Gatchina (RU)

(72) Inventors: Marat Gilmutdinov, Saint-Petersburg (RU); Anton Veselov, Saint-Petersburg (RU); Ivan Grokhotkov, Gatchina (RU)

(21) Appl. No.: 13/976,542

(22) PCT Filed: Dec. 22, 2011
(86) PCT No.: PCT/RU2011/001020

§ 371 Date: Jun. 27, 2013

(51) Int. Cl. H04N 7/36

(52) U.S. Cl. CPC H04N 19/00587
USPC 375/240.16

(57) ABSTRACT

In some embodiments, iterative schemes allowing for the creation of complexity scalable frame-rate up-conversion (FRUC), on the basis of bilateral block-matching searches, may be provided. Such approaches may improve the accuracy of calculated motion vectors at each iteration. Iterative searches with variable block sizes may be employed. It may begin with larger block sizes, to find global motion within a frame, and then proceed to using smaller block sizes for local motion regions.

### BACKGROUND

The present invention relates generally to frame rate up conversion (FRUC). Modern frame rate up-conversion schemes are generally based on temporal motion compensated frame interpolation (MCFI). An important challenge in this task is the calculation of the motion vectors reflecting true motion, the actual trajectory of an object's movement between successive frames.

Typical FRUC schemes use block-matching based motion estimation (ME), whereby a result is attained through minimization of the residual frame energy, but unfortunately, it does not reflect true motion. Accordingly, new approaches for frame rate up conversion would be desired.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a frame rate up-converter (FRUC) module in accordance with some embodiments.

FIGS. 2A-2B are diagrams illustrating the removal of frame borders.

FIG. 3 is a diagram showing a hierarchal motion estimation iteration in accordance with some embodiments.

FIG. 4A is a diagram showing a routine for performing a bilateral motion estimation iteration in accordance with some embodiments.

FIG. 4B is a diagram showing a routine for performing a bilateral gradient search in accordance with some embodiments.

FIG. 5 is a diagram showing relative pixel positions for a gradient search in accordance with some embodiments.

FIG. 6 represents motion vectors used in an additional search in accordance with some embodiments.

FIG. 7 illustrates an example of motion estimation with dynamically scalable complexity in accordance with some embodiments.

FIG. 8 is a system diagram of a computing system having a graphics processing unit with a frame rate up-converter in accordance with some embodiments.

### DETAILED DESCRIPTION

In some embodiments, iterative schemes allowing for the creation of complexity scalable frame-rate up-conversion (FRUC), on the basis of bilateral block-matching searches, may be provided. Such approaches may improve the accuracy of calculated motion vectors at each iteration. Iterative searches with variable block sizes may be employed. It may begin with larger block sizes, to find global motion within a frame, and then proceed to using smaller block sizes for local motion regions. In some embodiments, to avoid the problems connected with holes resulting from occlusions on the interpolated frame, bilateral motion estimation may be used. With this approach, the complexity of frame interpolation, using the calculated motion vectors, may be varied, e.g., reduced when higher frame quality is not required.

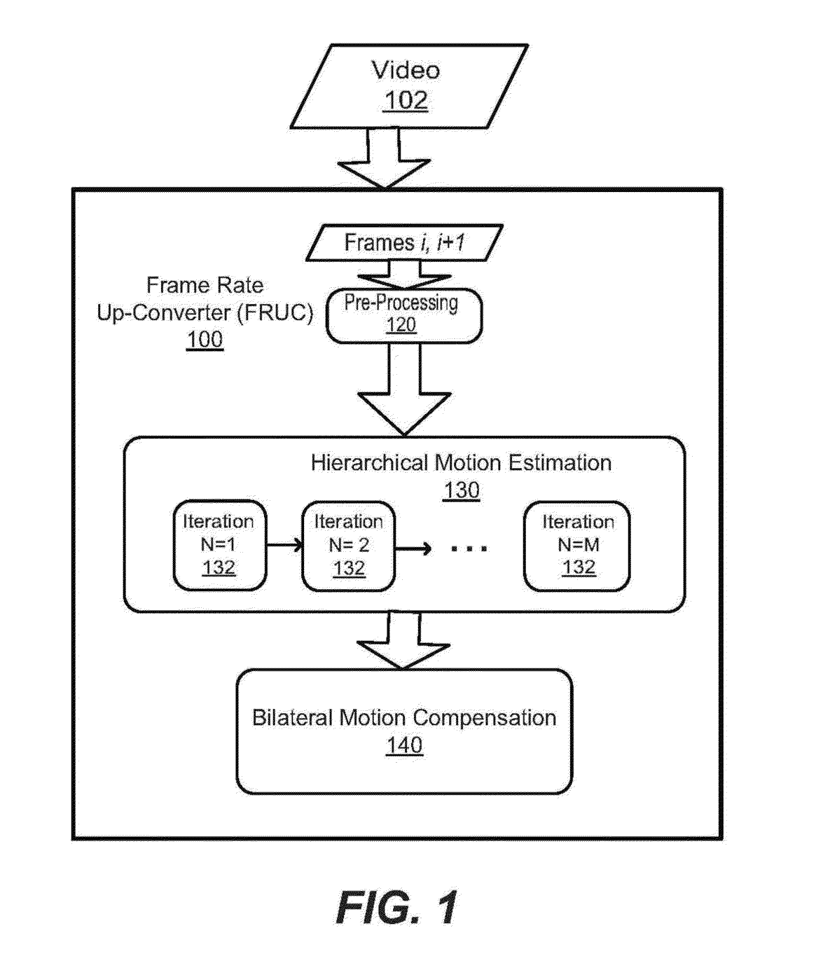

FIG. 1 is a block diagram showing a frame rate up-conversion (FRUC) module 100 in accordance with some embodiments. It receives video frame data 102, from which it generates an up-converted video frame signal (or file) to be provided to a display. A FRUC module may be employed in any suitable manner (hardware, software, combination) and/or in any suitable application. For example, it could be implemented in a graphics processing unit or in a video codec, for a personal computer, a television appliance, or the like. Moreover, it could be employed in a variety of video formats including but not limited to H.264, VC1, and VP8.

In the depicted embodiment, the frame rate up-converter 100 comprises a frames preprocessing component 120, a hierarchical motion estimator (ME) component 130, and a bilateral motion compensation component 140. The motion estimation component 130 employs (e.g., dynamically, depending on a given file or frame group) one or more (M=one or more) motion estimation iterations 132.

In some embodiments, the FRUC works on two consecutive frames (Frames i, i+1) at a time, until it works its way through an entire file of frames, inserting new frames between the i and i+1 frame sets. So, if it inserts an interpolated frame between each and i^{th}+1 frame, then it doubles the number of frames in the file for a 2× frame rate up-conversion. (Of course, this could be repeated one or ore times for different FRUC multiples of 2.)

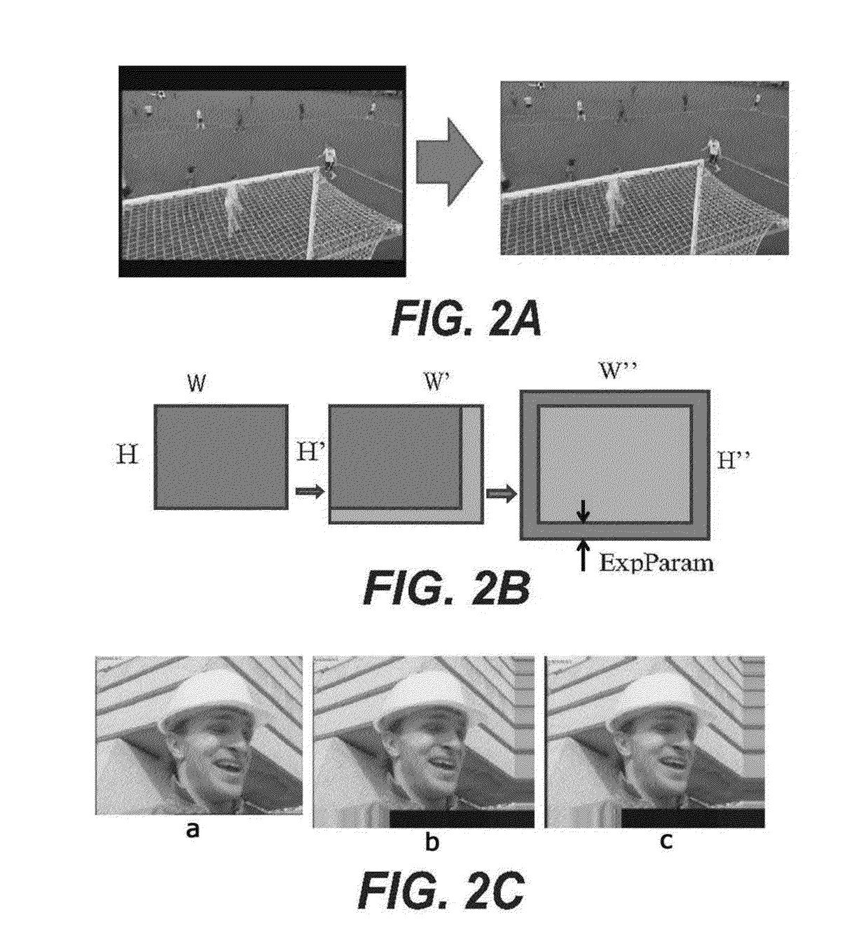

Frame components preprocessing (120) involves removing the black border, as represented in FIG. 2A, from the frames and to further, expand the frames to suit maximum block size (FIGS. 2B and 2C).

Frame components preprocessing may involve removing a frame's black border and performing frame expansion.

With reference to FIG. 2A, border removal may be performed. A border may be defined with a proposition that a row or column belongs to a frame's border if all its pixel values are less than some pre-defined threshold. An algorithm for detecting borders may be applied to the previous frame (i−1 frame). The detected borders coordinates are used to cut the borders from both previous and next frames. In some embodiments, frame components preprocessing workflow may be implemented in the following manner

Initially, borders are detected. The top, left, bottom, and right borders may be detected as follows:

top=max({i:leq(Yprev_{0,0}^{i,W}, FrameBorderThr)=1})

left=max({j:leq(Yprev_{0,0}^{H,j}, FrameBorderThr)=1})

bottom=max({i:leq(Yprev_{H-i,0}^{H,W}, FrameBorderThr)=1})

right=max({j:leq(Yprev_{0,W . . . j}^{H,W}, FrameBorderThr)=1})

where max(X) returns the maximal element in a set X,

$$all ( X ) = \{ \begin{matrix}1 , & if all elements in X are lower than or equal to thr \\ 0 , & else\end{matrix} ,$$

and
Y_{l,μ}^{r,d} denotes Rectangle area in lama frame Y; l,μ—coordinates of left up area corner; r,d—coordinates of right down area corner.

Next, the detected black border is removed,

where

Yprev=Yprev_{top+1,left+1}^{bottom . . . 1, right . . . 1}

and

Ynext=Ynext_{top+1,left+1}^{bottom . . . 1, right . . .1}

Frame expansion may be performed in any suitable manner. For example, frames may be padded to suit the block size. The frame dimensions should be divisible by the block size. To provide this additional frame content, rows and columns may be added to the left and bottom borders of the frames (FIG. 2B-b). Then several rows and columns may be appended to the frame borders (FIG. 2B-c). The final expansion is illustrated in FIG. 2C.

The hierarchal motion estimation block has N=M iterations 132. More or less may be employed depending on desired frame quality versus processing complexity. Each iteration may use different parameters, e.g., smaller block sizes may be used for bilateral motion estimation tasks as the iterations progress.

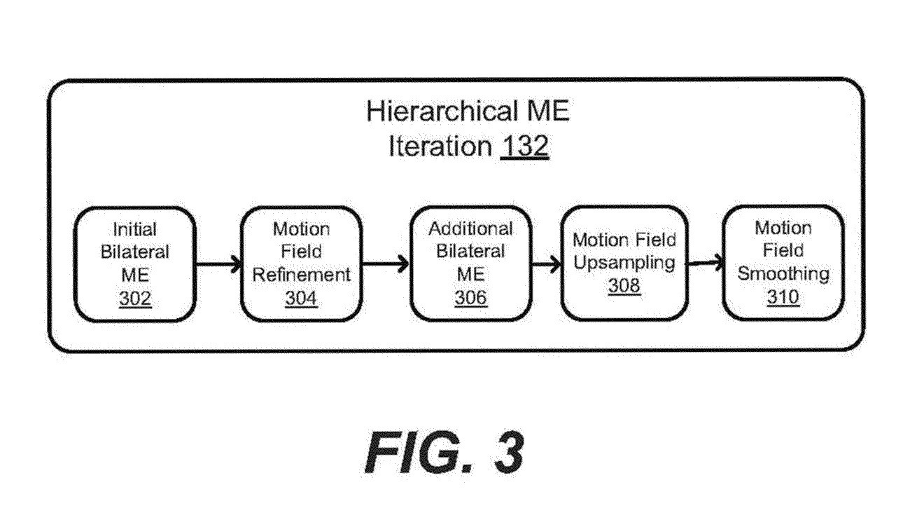

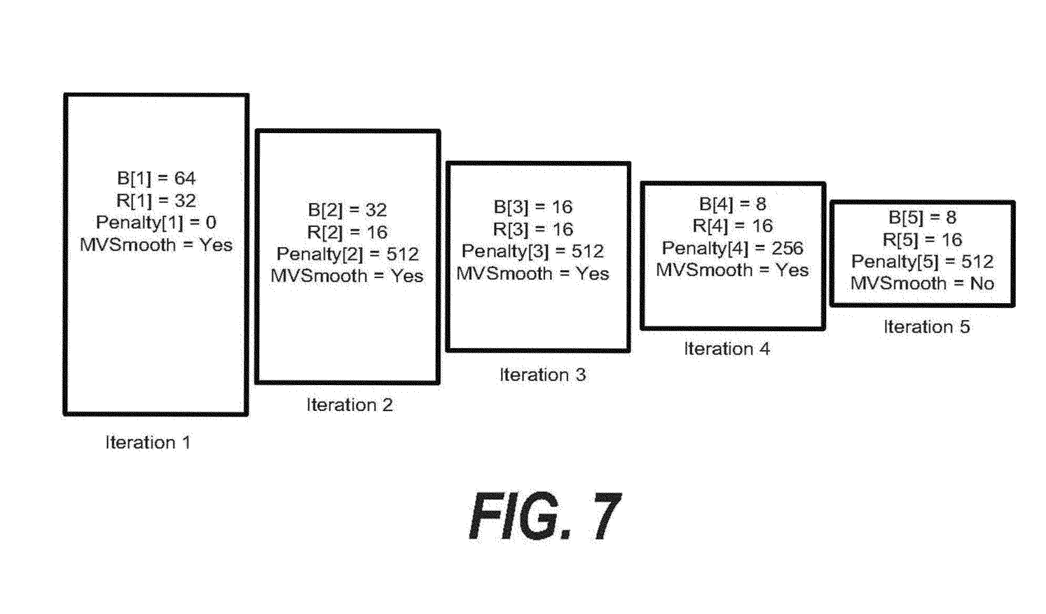

FIG. 3 is a diagram showing a hierarchal motion estimation iteration 132 in accordance with some embodiments. Each hierarchal ME iteration 132 may include the following stages: initial bilateral ME (302), motion field refinement (304), additional bilateral ME (306), motion field up-sampling (308), and motion field smoothing (310), performed in an order as shown. The initial and additional bilateral motion estimation stages (302, 306) will have associated parameters including block size (B[N], radius (R[N]) and a penalty parameter. Motion field smoothing (310) is an optional stage, and thus, effectively has a Boolean parameter value (yes or no) for each iteration. These parameter values may, and likely should, change for each successive iteration. (This is visually depicted in FIG. 7, which has M=5 hierarchal motion estimation iterations.)

The block size (B[n]) should generally be a power of 2 (e.g., 64×64, 32×32, etc.). (Within this description, “n” refers to the stage in the ME process.) There may be other ME stage parameters including R[n], Penalty[n], and FrameBorderThr. R[n] is the search radius for the nth stage, the maximum steps in gradient search (e.g., 16 . . . 32). The Penalty[n] is a value used in a gradient search, and Frame Border Thr is the threshold for block frame border removal (e.g., 16 . . . 18). Additional parameters could include: ExpParam and ErrorThr. ExpParam is the number of pixels added to each picture border for expansion (e.g., 0 . . . 32), and ErrorThr is the threshold for motion vectors reliability classification.

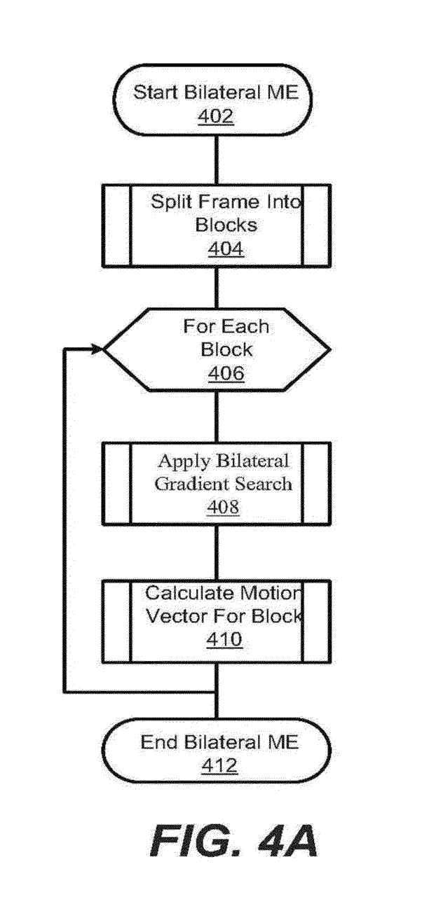

FIGS. 4A and 4B show routines for performing bilateral motion estimation (FIG. 4A) and a bilateral gradient search (FIG. 4B), which may be used for the bilateral motion estimation routine. This bilateral motion estimation routine may be used for hierarchal motion estimation stages 302 and 306. The input to this routine are two successive frames (i, i+1), and the returned value is a motion vector for the frame (to be interpolated) that is disposed the two successive frames.

Starting with bilateral ME routine 402, initially, at 404, a frame (e.g., for the i and i+1 frames) is split into blocks, B[N]. Then, for each block (at 406), a bilateral gradient search is applied at 408, and, at 410, a motion vector is calculated for the block. FIG. 4B shows a routine 422 for performing a gradient search in accordance with some embodiments. This gradient search uses penalties, but any suitable known, or presently not known, bilateral gradient search process may suffice. With this gradient search routine, the ME result may be a motion field comprising two arrays: (ΔX and ΔY) of integer values in the range (−R[n] to R[n]], where R[n] is a radius of the search on stage number n. Both arrays have (W/B[n],H/B[n]) resolution, where B[n] is the block size on iteration number n, and W and H are expanded frame width and height.

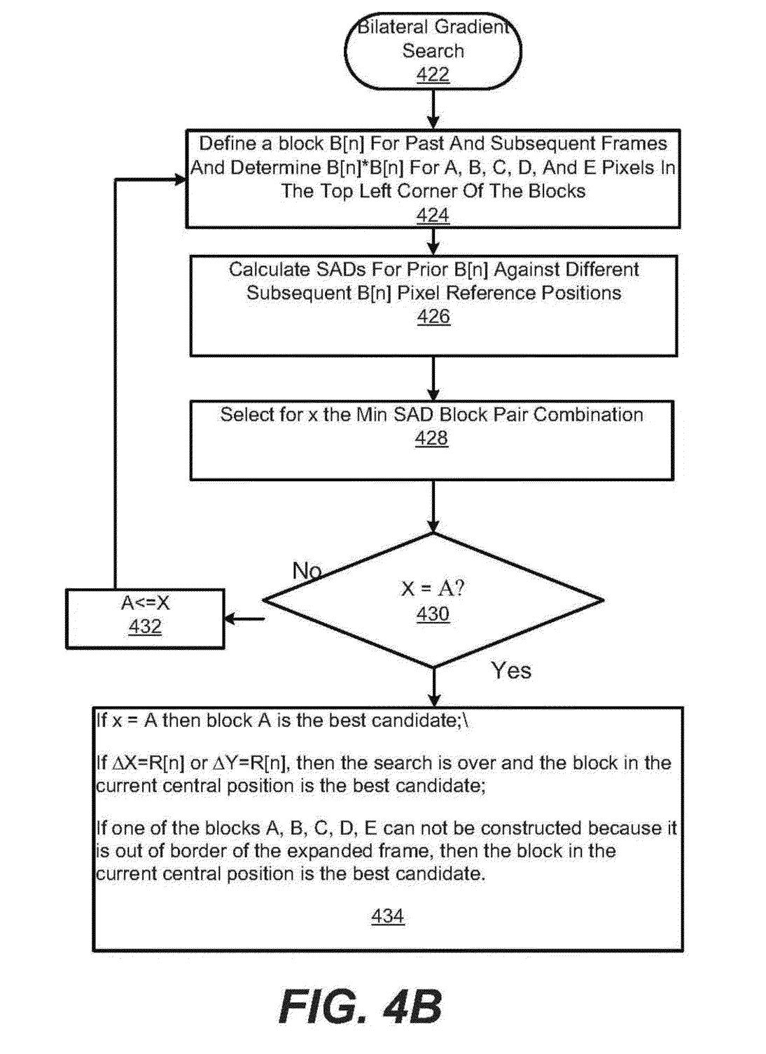

With additional reference to FIG. 5, at 424, let A, B, C, D and E be the neighbor pixels in the past (t−1) and future (t+1) frames. The blocks B[n]*B[n] are constructed so that A, B, C, D and E pixels are in the top left corner of the blocks.

Next, at 426, a sum of absolute differences (SAD) is calculated between blocks from the current frame and the five blocks from the prior frame with penalties. {SAD(A), SAD(B)+ penalty[n], SAD(C)+ penalty[n], SAD(D)+ penalty[n], SAD(E)+ penalty[n]}, where Penalty [n] is the predefined penalty for stage n. Next, at 428, the block pair with minimal SAD value is selected: X=argmin(SAD(i)).

At 430, if X is not equal to A, then at 432, A is assigned X, and the routine loops back to 424. Otherwise, it proceeds to 434 and determines: if x=A then block A is the best candidate; if ΔX=R[n] or ΔY=R[n], then the search is over and the block in the current central position is the best candidate. If one of the blocks A, B, C, D, E can not be constructed because it is out of border of the expanded frame, then the block in the current central position is the best candidate.

From here, the motion vector may be determined (at 410). Again, this process may be used for both the initial and additional bilateral ME states (302 and 306) within the hierarchal motion estimation pipeline 130.

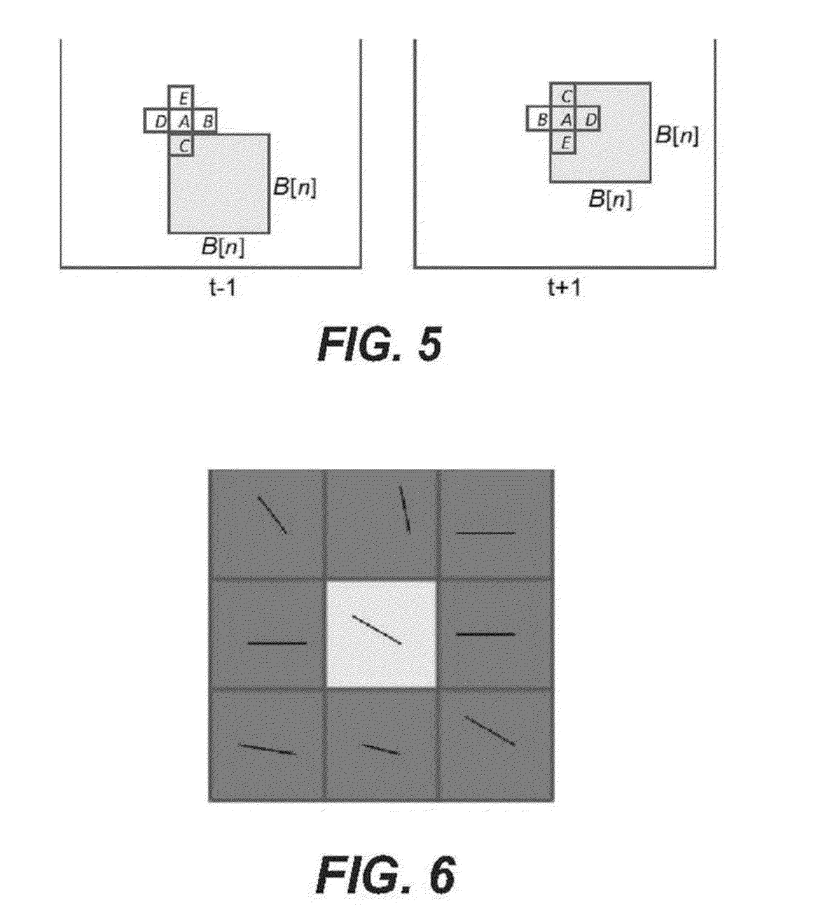

After the initial bilateral ME stage 302, a motion field refinement stage (304) may be performed. It is used to estimate the reliability of the motion vectors found on the initial bilateral motion estimation. This procedure is not necessarily fixed but should divide the motion vectors into two classes: reliable and unreliable. Any suitable motion vector reliability and/or classification scheme may be employed. From this, the derived reliable vectors are used in the next hierarchal ME stage, additional bilateral ME (306), which allows for more accurate detection of true motion. If employed, the employed bilateral gradient search may have a starting point that may be calculated the following way: startX=x+mvx(y+i,x+j) and startY=y+mvy(y+i,x+j), where x and y are coordinates of the current block, and mvx and mvy are motion vectors from a neighboring reliable block with coordinates y+I, x+j. The output of the additional search will typically be the best vector from the block aperture of size 3×3 (see FIG. 6, which represents motion vectors used in the additional search). Note that for this, or other stages in a motion estimation stage, the motion vectors, calculated for luma components, may be used for chroma components as well.

After the additional bilateral motion estimation stage, the next stage (308) is motion field up-scaling, where the ME motion vector fields are up-scaled for the next ME iteration (if there is a “next” iteration). Any suitable known processes may be used for this stage.

The last stage (310) is motion field smoothing. As an example, a 5×5 Gaussian kernel, such as the following kernel, could be used.

$$\vert \begin{matrix}24 & 35 & 39 & 35 & 24 \\ 35 & 50 & 57 & 50 & 35 \\ 39 & 57 & 64 & 57 & 39 \\ 35 & 50 & 57 & 50 & 35 \\ 24 & 35 & 39 & 35 & 24\end{matrix} \vert$$

Depending on N, the number of hierarchal motion estimation iterations that are to be performed, an additional iteration may be undertaken, once again starting at 302. Alternatively, if the N iterations have been completed, then at 140 (FIG. 1), the process proceeds to perform a bilateral motion compensation (MC) operation.

Motion compensation may be done in any suitable way. For example, an overlapped block motion compensation (OBMC) procedure may be used to construct the interpolated frame. Overlapped block motion compensation (OBMC) is generally known and is typically formulated from probabilistic linear estimates of pixel intensities, given that limited block motion information is generally available to the decoder. In some embodiments, OBMC may predict the current frame of a sequence by re-positioning overlapping blocks of pixels from the previous frame, each weighted by some smooth window. Under favorable conditions, OBMC may provide reductions in prediction error, even with little (or no) change in the encoder's search and without extra side information. Performance can be further enhanced with the use of state variable conditioning in the compensation process.

FIG. 7 illustrates an example of motion estimation with dynamically scalable complexity in accordance with some embodiments. The height of each box corresponds to the complexity of its processing iteration. As can be seen, with each successive iteration, the complexity decreases. With this example, there are 5 iterations (N=5). The block sizes, for each successive iteration, are: 64, 32, 16, 8, and 4. With these blocks, Search radiuses of 32, 16, 16, 16, and 1, respectively, are used. The same parameters used for the initial bilateral ME (302) were used for the additional bilateral ME (306). Note that motion vector smoothing is performed at every iteration, except the last one (block size 4 in this example).

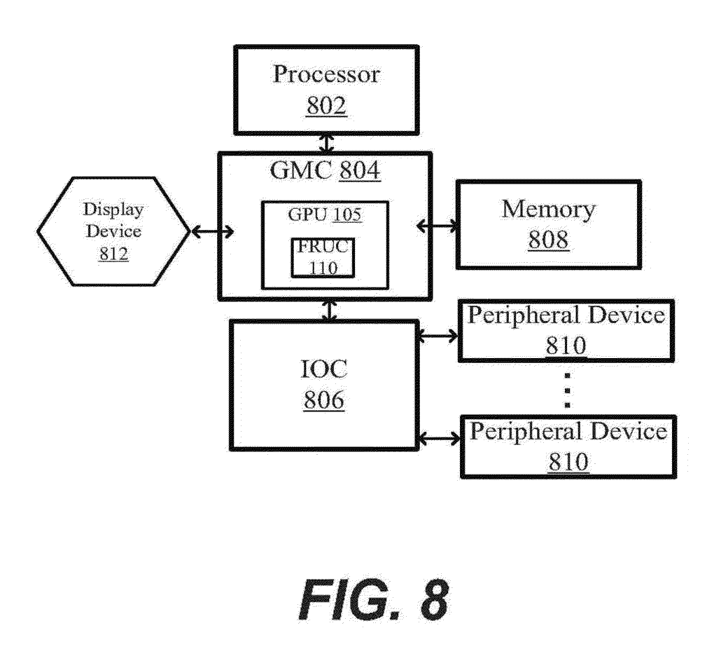

FIG. 8 shows a portion of an exemplary computing system. It comprises a processor 802 (or central processing unit “CPU”), a graphics/memory controller (GMC) 804, an input/output controller (IOC) 806, memory 808, peripheral devices/ports 810, and a display device 812, all coupled together as shown. The processor 802 may comprise one or more cores in one or more packages and functions to facilitate central processing tasks including executing one or more applications.

The GMC 804 controls access to memory 808 from both the processor 802 and IOC 806. It also comprises a graphics processing unit 105 to generate video frames for application(s) running in the processor 802 to be displayed on the display device 812. The GPU 105 comprises a frame-rate up-converter (FRUC) 110, which may be implemented as discussed herein.

The IOC 806 controls access between the peripheral devices/ports 810 and the other blocks in the system. The peripheral devices may include, for example, peripheral chip interconnect (PCI) and/or PCI Express ports, universal serial bus (USB) ports, network wireless network) devices, user interface devices such as keypads, mice, and any other devices that may interface with the computing system.

The FRUC 110 may comprise any suitable combination of hardware and or software to generate higher frame rates. For example, it may be implemented as an executable software routine, e.g., in a GPU driver, or it may wholly or partially be implemented with dedicated or shared arithmetic or other logic circuitry. it may comprise any suitable combination of hardware and/or software, implemented in and/or external to a GPU to up-convert frame rate.

In the preceding description, numerous specific details have been set forth. However, it is understood that embodiments of the invention may be practiced without these specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

1. A chip, comprising:
a FRUC module to perform motion estimation through one or more complexity scalable iterations that each include (a) an initial bilateral motion estimation, (b) a motion field refinement, and (c) additional bilateral motion estimation.

2. The chip of claim 1, in which the initial bilateral motion estimation stage for each iteration uses different gradient search block sizes.

3. The chip of claim 1, in which the FRUC is FRUC is part of a GPU in a system on a chip (SoC).

4. The chip of claim 3, in which the GPU is to perform a bilateral motion compensation operation after the motion estimation operation is finished.

5. The chip of claim 1, in which the complexity scalable iterations comprise searches on successively smaller block sizes for each iteration.

6. The chip of claim 5, in which the complexity scalable iterations comprise a dynamic search radius parameter.

7. A method, comprising:
performing a hierarchal motion estimation operation to generate a new frame from first and second frames, the new frame to be disposed between the first and second frames, said hierarchal motion estimation comprising performing two or more process iterations, each iteration including:
(a) performing an initial bilateral motion estimation operation on the first and second frames to produce a motion field;
(b) performing a motion field refinement operation for the first and second frames and motion field, and
(c) performing an additional bilateral motion estimation operation on the refined first and second frames.

8. The method of claim 7, in which the bilateral motion estimation operations comprise bilateral gradient search operations.

9. The method of claim 7, in which a bilateral motion compensation operation is performed after the two or more process iterations are completed.

10. The method of claim 7, in which the hierarchal motion estimation comprises searches using successively smaller block sizes for each successive iteration.

11. The method of claim 10, in which the iterations comprise a dynamic search radius parameter.

12. A me memory storage device having instructions, when executed by a processor, perform frame rate up conversion comprising:
performing two or more hierarchal motion estimation iterations each including:
(a) performing an initial bilateral motion estimation operation on first and second frames to produce a motion field;
(b) performing a motion field refinement operation for the first and second frames and motion field, and
(c) performing an additional bilateral motion estimation operation on the refined first and second frames.

13. The memory storage device of claim 12, in which the bilateral motion estimation operations comprise bilateral gradient search operations.

14. The memory storage device of claim 12, in which a bilateral motion compensation operation is performed after the two or more process iterations are completed.

15. The memory storage device of claim 12, in which the hierarchal motion estimation comprises searches using successively smaller block sizes for each successive iteration.

16. The memory storage device of claim 12, in which the iterations comprise a dynamic search radius parameter.
